(19) United States
(12) Patent Application Publication
(10) Pub. No.: US 2012/0057920 A1
(43) Pub. Date: Mar. 8, 2012

(54) WRITING IMPLEMENT WITH MAGNETIC REPULSION

(75) Inventor: Frank Rolion, Asnieres sur Oise (FR)

(73) Assignee: SOCIETE BIC, Clichy Cedex, (FR)

(21) Appl. No.: 13/321,034

(22) PCT Filed: May 18, 2010
(86) PCT No.: PCT/FR2010/050961

§ 371 Date: Nov. 17, 2011

(30) Foreign Application Priority Data
May 19, 2009 (FR) FR 09 53337
May 18, 2010 (FR) PCT/FR2010/050961

(51) Int. Cl. B43K 24/02

(52) U.S. Cl. 401/100

(57) ABSTRACT

A writing implement that includes a tubular body that extends longitudinally between a front end and a back end; a writing member that is movable relative to the body between an extended position in which the writing member projects from the front of the body and a retracted position in which the writing member is housed inside the body; a first magnetic member secured to the writing member and movable with it; and a selection device that includes a second magnetic member and an actuation member A, adapted for moving from a first configuration of the device in which the writing member is in the retracted position, to a second configuration in which the writing member is in the extended position.

### CROSS REFERENCE TO RELATED APPLICATION

This application is a national stage application of International Application No. PCT/FR2010/050961 filed on May 18, 2010, which claims priority to French Patent Application No. 09 53337 filed on May 19, 2009, the entire contents of both applications being incorporated herein by reference.

### FIELD OF INVENTION

The embodiments of the present invention relate to a writing implement such as an ink pen, and particularly to a writing implement that includes:
a tubular body extending longitudinally between a front end and a back end;
a writing member that is movable relative to the body between an extended position in which the writing member projects from the front of the body and a retracted position in which the writing member is housed inside the body;
a first magnetic member secured to the writing member and movable with it; and
a selection device comprising a second magnetic member and an actuation member, adapted for moving from a first configuration of the device in which the writing member is in the retracted position, to a second configuration in which the writing member is in the extended position.

### BACKGROUND OF THE INVENTION

A writing implement of the above type avoids the use of a spring. Document WO2004060697 discloses a magnetic device for extending/retracting the tip of a ballpoint pen. This device comprises a magnet secured to the tip to slide with it and an actuating magnet which attracts the sliding magnet to obtain the retracted position. The extended position of the writing tip is obtained by rotating the actuation magnet around an axis (in particular, see the embodiment in FIG. 5 of document WO2004060697). This type of implement allows selecting the position of the writing element and simultaneously immobilizing the writing element in the selected position by means of the “bond” magnetically established between a magnet secured to the tip and the rotatably-actuated magnet.

Also known, from document U.S. Pat. No. 3,063,419, is a writing instrument which allows actuating and maintaining a writing position. The actuation is magnetic, by rotating a first magnet placed in a knob outside the tubular body. This first magnet exerts a repulsion force on a second internal magnet secured to the writing element. From the effect of the repulsion, the writing member lodges in a retaining zone defined by a retaining surface or elements in proximity to the front end of the tubular body, so that the extended position of the writing member is fixed while writing. This extended position can only be modified by inverting the magnetic forces exerted between the first magnet and the second magnet, which of course causes a return to the retracted position.

Such instruments do not adjust to the writing pressure, however.

A need exists for writing implements which are comfortable to use, are compatible with the possibility of retracting the writing member, and are preferably economical.

### SUMMARY OF THE EMBODIMENTS OF THE PRESENT INVENTION

An aim of the embodiments of the present invention is to provide a writing implement with an easily actuated retractable tip which adapts better to certain incidents when writing, while remaining simple in design.

For this purpose, the writing implement of the invention has a first configuration in which the first and second magnetic members have opposite magnetic poles in contact with each other, and in the second configuration the first and second magnetic members have poles of the same polarity substantially facing one another, generating a repulsion force which urges the writing member towards a maximum extended position in which the writing member is in contact with a longitudinal abutment of the body and remains backwardly movable, the repulsion force in the second configuration being adapted to cushion a writing pressure, the second magnetic member rotating on a pivot axis by a predetermined angle between the two configurations.

Thus the writing member is advantageously associated with a magnetic cushioning system which pushes it towards the most extended position to enable writing. This configuration is both ergonomic and compact: it is not necessary to move one magnet far away from the other, as a simple rotation is sufficient.

For the user, this enhances usability. The magnetic cushioning of the writing tip reduces the risk of tearing the paper (if the user exerts excessive pressure) without causing any discomfort while writing. The non-linearity of the repulsion (less repulsion at the start) also allows rearward motion while reacting very significantly to excessive pressure, which limits the risk of the writing point retracting in this configuration.

According to a particular characteristic of the invention, the first magnetic member and the second magnetic member are arranged inside the body. This arrangement integrates the magnets in a compact manner and protects the faces of the magnetic members from outside contaminants.

According to a particular characteristic, the first and second magnetic members have faces in planes transverse to the body in the first and second configurations. These faces are typically flat, so that the magnetic forces of attraction and repulsion are maximized as contact approaches (parallel field lines).

According to another particular characteristic, the body has locking members which lock the actuation member in positions corresponding to the first and second configurations. Locking the writing tip in position is achieved simply by retaining the actuation member with, for example, irregularities formed on the outside of the body. This arrangement avoids establishing the lock with a part housed within the inside volume of the body of the writing implement.

According to another particular characteristic, the actuation member is an elongated member extending along the outer wall of the body, preferably for a length substantially greater than the largest dimension of the second magnetic member. This provides a comfortable grip for the user during actuation. The dimensions of the actuation member are large compared with those of the magnetic member (the size of the latter is thus limited to the inside of the implement).

In another particular characteristic, the actuation member is pivotably mounted on a transverse axis. This arrangement with a transverse axis of rotation minimizes the torque that must be exerted to separate the second magnetic member from the tangential face of the first magnetic member. The user can thus change from the second configuration to the first configuration without excessive effort. The actuation member can define a clip. This minimizes the number of parts because the user can use the same part as an actuator and as an attachment (to the front pocket of a shirt for example).

According to another particular characteristic, the actuation member is secured to a pin defining the pivot axis and bearing an internal support onto which the second magnetic member is mounted. The support, the pin, and the actuation member are formed as a single part. This arrangement allows one part to fulfill numerous functions. The pin also houses the second magnetic member in a compact manner and does not allow it to slide axially.

According to another particular characteristic, the second magnetic member is rotationally movable relative to a longitudinal axis and is secured to the actuation member. The pivoting mechanism for the magnet is therefore particularly simple.

According to another particular characteristic, the selection device additionally comprises a mechanism connecting the actuation member to the pivot axis of the second magnetic member, the mechanism being adapted so that the second magnetic member moves forward when the selection device is changed from the first configuration to the second configuration, and the second magnetic member moves backward when the selection device is changed from the second configuration to the first configuration. This arrangement lengthens the path so that the writing tip is extended by an appropriate distance, without introducing too much space between the magnets in the use position. Typically in this case the magnets have multipole faces.

According to a particular characteristic, a shoulder of the writing member is in contact with the longitudinal abutment in the maximum extended position.

### BRIEF DESCRIPTION OF THE DRAWINGS

Other features and advantages of the embodiments of the present invention will be apparent from reading the following description of several embodiments provided as non-limiting examples, with reference to the attached drawings in which:

FIG. 1 is a longitudinal cross-sectional view of a writing implement according to a first embodiment of the invention, with the writing tip in the extended position;

FIGS. 2A and 2B respectively represent a longitudinal cross-sectional view and a perspective view of the writing implement of FIG. 1, with the writing tip in the retracted position;

FIG. 3 is a front view of a portion of a writing implement according to the first embodiment of the invention;

FIG. 4 is a perspective view of a portion of a writing implement according to the first embodiment of the invention;

FIGS. 5A and 5B each represent a longitudinal cross-sectional view of a writing implement according to a second embodiment of the invention, respectively with the writing tip in the extended position and in the retracted position;

FIG. 6 is a perspective view of the writing implement of FIGS. 5A-5B;

FIG. 7 is a longitudinal cross-sectional view detailing the back end of a writing implement according to the second embodiment of the invention;

FIGS. 8 and 9 are perspective views detailing parts of the writing implement of FIGS. 5A-5B and 6;

FIG. 10 represents details of a variant embodiment of a writing implement according to the invention.

### DESCRIPTION OF PREFERRED EMBODIMENTS OF THE INVENTION

In the different figures, the same references denote the same or similar elements. The writing implement 1 allows writing in any writing, erasing, or highlighting medium, referred to as ink in the following description, by means of a writing tip 2.

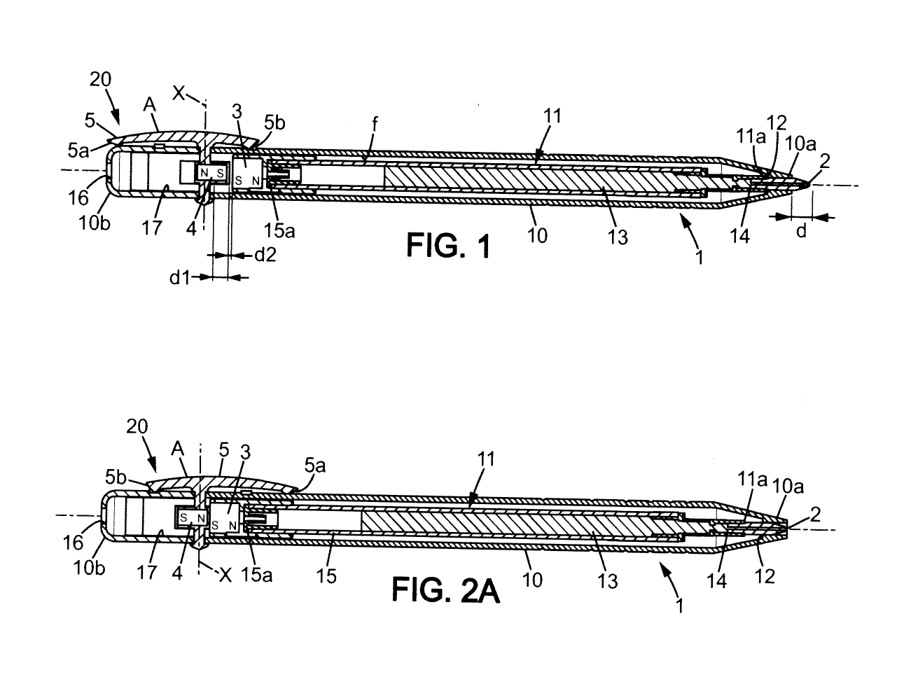

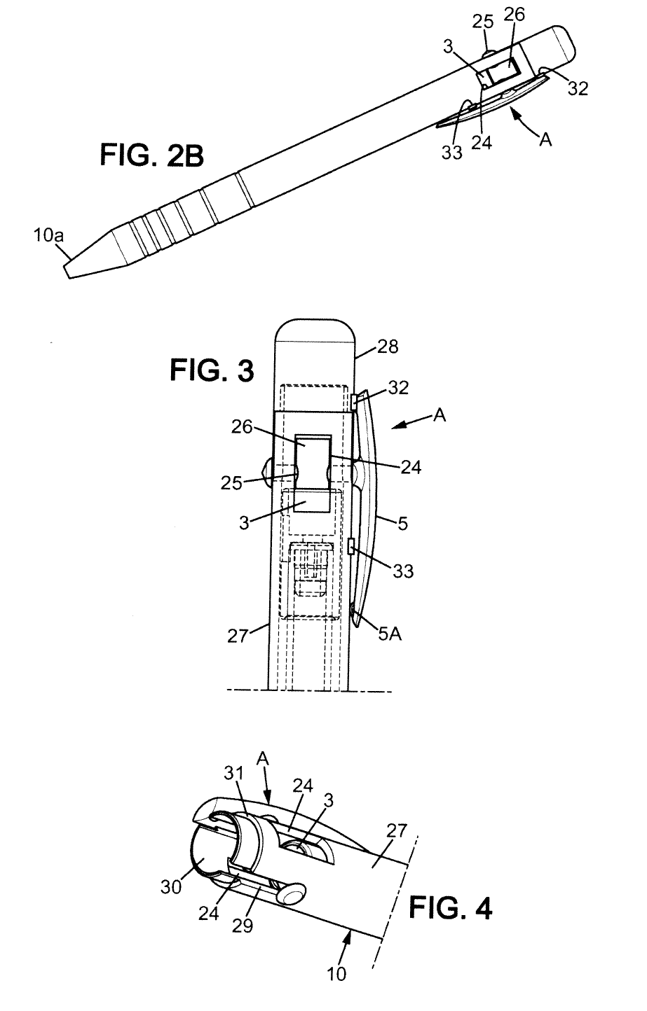

With reference to FIGS. 1 and 2A-2B in particular, the writing implement 1 is shown without a cap, and the writing tip 2 is retracted by means of a system of a pair of magnets 3, 4. In the retracted position, the writing tip 2 is not projecting, and therefore cannot be used for writing. Moving the magnet 4 around a pivot axis X allows the writing tip 2 to change from one position to the other.

The writing implement 1 extends between a back end preferably equipped with a clip 5 and a front end, tapered for example and consisting of a conical portion or a similar arrangement. In a preferred embodiment, the writing implement 1 comprises a tubular body referred to in the following description as a barrel 10. In the non-limiting example in FIGS. 1 to 6, the two magnets 3,4 are arranged inside this barrel 10.

The writing tip 2 is part of a sliding apparatus 11 which comprises the first magnet 3 of the pair. The apparatus 11 is coaxial with the barrel 10 and has a shoulder 11a which is stopped by an abutment surface 12 of the barrel 10. This abutment surface 12 can be a ring and extend perpendicularly to the central axis 14 of the barrel 10. The internal face or faces f of the barrel 10 have guiding means, which are known, for guiding the apparatus 11 between an extended position of the writing tip 2 in which the front of the shoulder 11a is in contact with the abutment surface 12, and a withdrawn position of the writing tip 2. In the latter position, the first magnet 3 is touching or is as close as possible to the second magnet 4 which is connected to the barrel 10. Alternatively, more than two magnets can be used, for example, a magnetic member arranged between two other magnetic members.

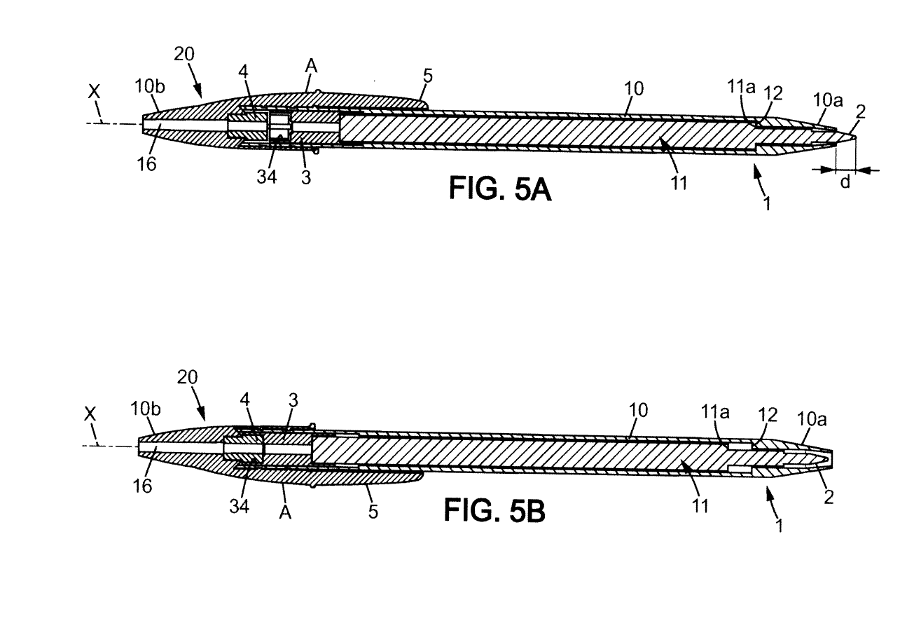

In the extended position as shown in FIGS. 1 and 5A, the writing tip 2 passes through a front opening and projects in relation to the front end 10a of the barrel 10 so that writing is possible. Here, the second magnet 4 is coaxial with the writing tip 2 in each of the configurations of the selection device 20. In a known manner, the writing tip 2 is supplied with ink 13 via a longitudinal passage 14 which communicates with the ink chamber 15. The apparatus 11 thus defines a writing unit. There is, for example, a vent hole 15a at the rear of the ink chamber 15 to allow air to pass freely. The barrel 10 has a rear opening 16 and a hollow 17 through which air can flow between the rear opening 16 and the vent hole 15a.

The hollow 17 also can house at least a part of the second magnet 4. The transverse section of this second magnet 4 is smaller than the transverse section of the hollow, allowing air to pass between the rear opening 10b and the vent hole 15a. In a less preferable embodiment, the air venting can be achieved other than by the back end 10b of the writing implement 1, for example in proximity to the front end 10a. In this case, the vent hole 15a communicates for example with a passage defined between the barrel 10 and the apparatus 11 and leading to the vent hole.

In FIGS. 1, 2A and 5A-5B, a selection device 20 is illustrated which comprises the magnet 4 and an actuation member A that controls the rotational movement of the second magnet 4. This selection device 20 can, for example, pivot around the axis X of the magnet 4. The magnet thus rotates by a predetermined angle when the selection device 20 changes from a first configuration corresponding to the retracted position to a second configuration corresponding to the extended position. The actuation member A is preferably an elongated member extending along the outside wall of the barrel 10 and has dimensions much greater than those of the second magnet 4 to facilitate manipulation by the user and to reduce the volume required inside the barrel 10. In particular, the length of the actuation member A is for example at least two times greater, and even better at least three times greater, than the largest dimension of the magnet 4.

One can see the retracted position in FIGS. 2A and 5B, in which the two magnets 3,4 are in contact due to the attraction between magnetic poles of complementary polarity. The selection device 20 is then in its first configuration. When the user rotates the actuation member A around the pivot axis X, for example by 180° in these non-limiting examples, the selection device 20 is placed in the second configuration which is illustrated in FIGS. 1 and 5A. Because of the rotation of the magnet 4, two poles of the same polarity are now facing each other and are therefore repulsing each other. The resulting repulsion force urges the writing tip 2 towards a maximum extended position. In this case, a shoulder 11a of the apparatus 11 presses axially against the abutment surface 12 of a longitudinal abutment of the barrel 10.

While the apparatus 11 retains its backward movability in the second configuration of the selection device 20, the repulsion force is sufficient to cushion the writing pressure. As a non-limiting example, a customary writing pressure can cause the writing tip 2 to retreat by 1 to 4 mm, while the amplitude d of the displacement of the writing tip 1 is for example on the order of 5 to 12 mm between the retracted and extended positions. The repulsion force can be about 1 Newton in the maximum extended position and 7 Newtons in a position of maximum stress in which the writing tip 2 is substantially at the same level as the front end 10a of the barrel 10.

A first embodiment will now be described in relation to FIGS. 1 to 4.

In FIG. 2A, when the writing tip 2 is in the retracted position, the south pole of the second magnet 4 is facing towards the back and the south pole defined by the back of the first magnet 3 is attracted by the front side of the second magnet. The rotation of the clip 5, constituting the main part of the actuation member A, relative to the barrel 10 causes the rotation of the second magnet 4. This rotation occurs around a transverse axis X.

As the rotation is 180° here, the first magnet 3 is now facing the other side of the second magnet 4, having the same polarity (south pole), as illustrated in FIG. 1. The repulsion between the magnetic fields causes a translation of the first magnet 3, which in turn causes a displacement of the writing tip 2. This repulsion is also exerted in the extended position of the writing tip 2, in a manner which magnetically cushions the writing pressure.

As can be seen in FIGS. 1 and 2A, the two sides of the magnet 4 are perpendicular to the direction in which the writing tip 2 is displaced, for both the extended position and the retracted position. To change to the extended position, the rotational movement around the transverse axis X facilitates breaking the magnetic bond between the two faces. FIGS. 2B and 3 show, the presence of a window 24 in the barrel 10 through which the second magnet 4 can be seen. This optional window 24 can be fitted with a transparent cover. In this embodiment, the activating member A is secured to a pin 25 which defines the pivot axis X. This pin 25 has an internal support 26 onto which the second magnet 4 is mounted. Here, the pin 25, the support 26, and the actuation member A are formed of a single part.

The pin 25 is for example closer to one of the poles, the north pole in this example, of the second magnet 4. This offset relative to a transverse median plane of the second magnet 4 contributes to breaking the magnetic bond between the two magnets 3, 4, due to a leverage effect. As can be seen in FIG. 1, this type of mechanism has the particular advantage of allowing the second magnet 4 to be placed more forward inside the barrel 10. More generally, the selection device 20 can comprise a mechanism between the actuation member A and the pin 25 for advancing the second magnet 4 when changing from the first configuration of the selection device 20 to the second configuration. One will understand that the amplitude d of the displacement of the writing tip 1 substantially corresponds to the sum “d1+d2”, where d1 represents the advancement distance resulting from the mechanism for rotating the second magnet 4 and d2 represents the distance which results from the force of the magnetic repulsion between the two magnets 3, 4. The distance d2 between the two facing sides of the two magnets 3,4 can be substantially less than the distance of advancement d1 for the maximum extended position of the writing tip 2, as is shown in the example in FIG. 1. One will understand that this advance/retreat mechanism for the magnet allows increasing the repulsion force. This force increases very strongly when the distance d2 is small.

With reference to FIG. 2A, the position of the second magnet 4 is further back than in FIG. 1. At the moment of the rotation to change to the retracted configuration, the maximum distance between the two complementary poles of the respective magnets 3, 4 is less than or equal to the distance d. Preferably, this distance is less than a threshold separation distance beyond which the attraction force no longer offsets the weight of the apparatus 11 which slides freely within the barrel 10.

The face corresponding to the repulsion pole of the second magnet 4, here the south pole, can pass through the window 24 when the second magnet 4 is in the rotation phase. FIG. 4 shows that two windows 24 can be provided on each side of the barrel 10, to allow a complete 360° rotation of the magnet around the pivot axis X without being prevented by the barrel 10. These windows 57 can also be eliminated, with the dimensions of the barrel and/or of the second magnet 4 being adjusted accordingly. It is understood that the barrel 10 can be larger in a variant embodiment, the barrel 10 being for example enlarged at least in the portion serving to house the magnetic device having two magnets 3,4.

In this example and as illustrated in FIGS. 3 and 4, the barrel 10 comprises two parts 27, 28 which are superimposed and which lock the pin 25 in a fixed longitudinal position. In particular, the barrel 10 has a primary part 27 which houses the sliding apparatus 11 and a rear part 28 which covers the magnetic device. The rear part 28 has two tabs which engage with two slits 29 of the primary part 27. Attachment is achieved for example by a tight fit of the rear part 28 onto the slotted end 30 of the main part 27, until the rear part 28 presses against the outer shoulders 31 of the main part. It is understood that within the inside volume of the primary part 27 of the barrel 10, the apparatus 11 can slide and is for example prevented from rotating by internal elements which guide the translational motion.

With reference to FIGS. 2A-2B and 3, the grippable part of the actuation member A corresponds to a fastener or a clip 5 having an attachment portion 5a extending towards the front end 10a of the barrel 10 when in the retracted position of the writing tip 2. The clip 5 has a dual purpose of attachment and of actuating the positions of the writing tip 2. The user can see that this attachment function is only available when the writing tip 2 is in the retracted position. Otherwise, as illustrated in FIG. 1, the clip 5 extends in the direction opposite that of the writing implement 1, which hinders or prevents hooking it onto the edge of any support (the main part of the writing implement 1 then cannot be attached to the support).

Placing the actuation member A on the side and housing the second magnet 4 inside the barrel 10 allows the writing implement not to have an actuation member taking up space at its back end 10b (better usability) and not exposing the faces of the magnet 4 to contact with the user. Another result is better impact resistance for this back end. In the first embodiment, the clip 5 defined by the actuation member A preferably has a cross-section that is generally not flattened in shape, for example oval or circular, to facilitate gripping.

As is illustrated in FIGS. 1-3, maintaining the position of the clip 5 relative to the barrel 10 can be achieved opposite the functional end of the clip 5. Rotation of the selection device 20 is for example blocked by insertion of a spur 5b into a retaining pocket formed on the barrel 10. In the example in FIG. 3, a pair of ribs 32 prevent the selection device 20 from rotating in a first configuration (retraction). Another pair of ribs 33 prevent the selection device 20 from rotating in the second configuration, in which the writing tip 2 is in the extended position. The respective pockets defined by each pair of ribs 32, 33 are here arranged in a longitudinal alignment. The portion of the pin 25 adjacent to the actuation member A is at a mid-point position in this alignment, at an equal distance from the two pairs of ribs 32, 33. In a variant embodiment, the respective pairs of ribs 32, 33 can be replaced by a protrusion cooperating with a slit in one end of the actuation member A.

More generally, it is understood that the barrel 10 has locking means 32, 33 which lock the actuation member A into the positions corresponding to the first and second configurations. In the example in FIGS. 1 to 3, the barrel 10 and the actuation member A are preferably each made of plastic material and in this case the locking can be achieved by elastically engaging, on a portion of the barrel 10, the spur 5b or similar protrusions formed as a part of the actuation member A.

A second embodiment will now be described with reference to FIGS. 5A to 9.

In this second embodiment, at least one of the first and second magnets 3, 4 has a side which is at least dipole, preferably flat, facing the other of the magnets 3, 4 in the respective configurations of the selection device 20. Although this second embodiment illustrates the use of two magnets 3, 4, it is understood that the second magnet 4 can also correspond to several magnets. The same is also true for the first magnet 3.

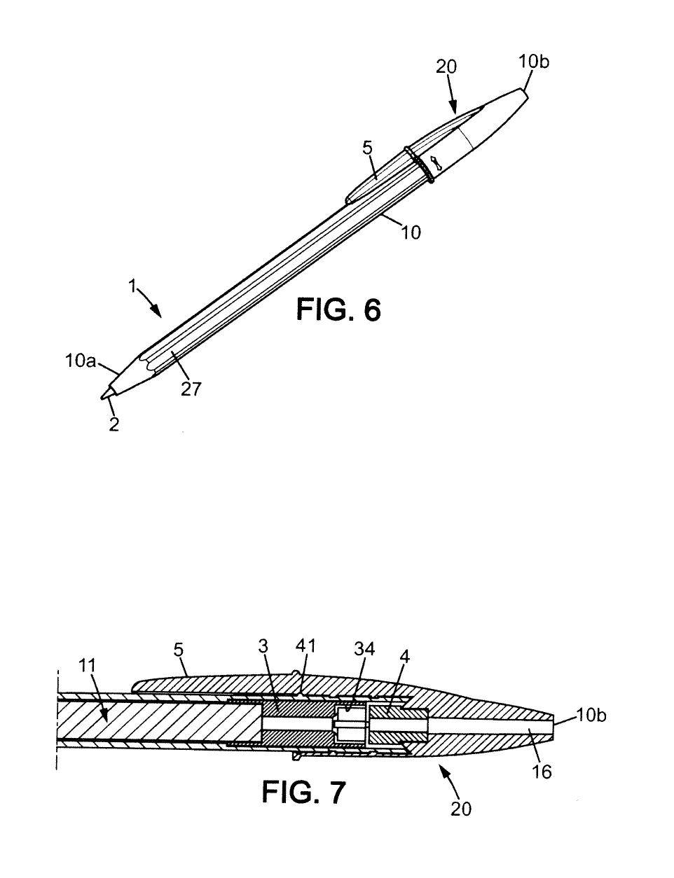

As illustrated in FIGS. 6 and 7, the writing implement 1 can have a selection device 20 which surrounds the back end of a tubular part 27 serving to house the sliding apparatus 11. Of course, in a variant, the part 27 can be replaced by an assembly of multiple parts. In this second embodiment, the selection device 20 is assembled to rotate around a longitudinal axis of the barrel 10. In particular, the selection device 20 comprises an actuation member A made preferably of one part and defining the back of the barrel 10. This actuation member A is assembled coaxially onto the tubular part 27, for example by means of a system of grooves and ribs and/or spurs.

With reference to FIGS. 5A and 5B, the writing tip 2 can be moved between an extended position (FIG. 5A) and a retracted position (FIG. 5B). As in the first embodiment, the respective poles of the magnets 3, 4 are mutually attracted when the sides facing each other have complementary magnetic field lines. Rotating the actuation member A relative to the tubular part 27 of the barrel 10 causes the rotation of the second magnet 4. This rotation occurs around a longitudinal axis X, for example the axis of symmetry of the tubular part 27.

Here the rotation is 180°, but a rotation of a smaller angle is possible as a variant. Each of the magnets 3, 4 is formed for example of a cylindrical part. Each end face of these magnets 3, 4 can then present, on each side of a longitudinal median plane, a zone forming a north pole and a zone forming a south pole. In a manner analogous to the first embodiment, when the writing tip 2 is in the withdrawn position (FIG. 5B), the field lines of each zone of the front face of the second magnet 4 are oriented in the same direction as the field lines of the facing zones of the first magnet 3.

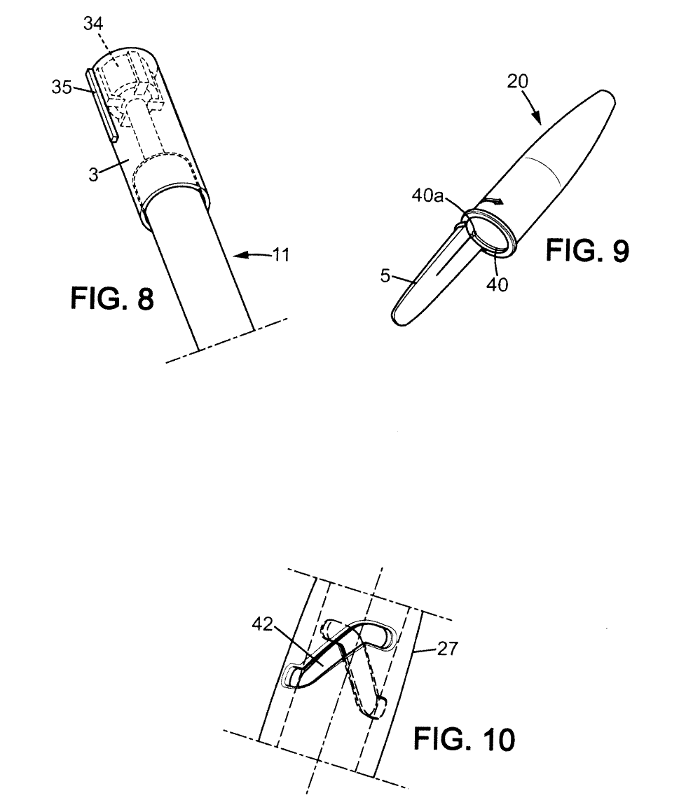

The two magnets 3, 4 are thus in contact or nearly in contact from the effect of the magnetic attraction. With reference to FIGS. 5B and 8, the first magnet connected to the writing tip 2 is in this case housed in a recess 34 in the part forming the second magnet 4.

Rotating the selection device 20 relative to the tubular part 27 causes the 180° rotation of the second magnet 4. For this new position of the second magnet 4 corresponding to the second configuration, the opposing zones in the magnetized faces exert a repulsive force. In this second configuration and as illustrated in FIG. 5A, the writing tip 2 advances by an amplitude of displacement d relative to its withdrawn position. In this example, the displacement of the writing tip 2 results solely from the repulsion force between the magnets 3, 4. The amplitude d is for example 0.5 to 1 mm greater than the displacement amplitude between the maximum extended position and the position of maximum stress.

As can be seen in 5A-5B and 7, the magnet 4 can be fixed within a recess in a cap-shaped part which defines the actuation member A of the selection device 20. Thus the second magnet 4 is not allowed to slide relative to the tubular part 27, unlike the apparatus 11. As illustrated in FIG. 8, the apparatus 11 can be guided in its translational motion by one or more longitudinal ribs 35 formed on the periphery of the part forming the first magnet 3. The sliding of the apparatus 11 is here completely analogous to that of the first embodiment. In the maximum extended position of the writing tip 2, represented in FIG. 5A, contact occurs between the abutment 12 and the shoulder 11A. The ribs 35 can also simultaneously press against a surface of the tubular part 27 in this maximum extended position of the apparatus 11.

In the non-limiting example in FIGS. 5A and 5B, each abutment surface preferably consists of a transverse surface of the tubular part 27. Thus the abutment surface 12 prevents the shoulder 11 A of the apparatus 11 from further forward motion. It is understood that sliding of the apparatus 11 can then be obtained during writing pressure without friction against an inner surface of the tubular part 27. This eliminates the risk of the apparatus 11 jamming.

With reference to FIGS. 7 and 9, the rotational displacement of the selection device 20 relative to the tubular part 27 is guided by one or more grooves 40 in the inner surface of the actuation member A. A spur 41 that is integral with the tubular part 27, visible in FIG. 7, moves within the groove 40 and can be locked in each of the two extreme positions of the rotational path of the selection device 20. The spur 41 is in more firm contact with the barrel at the ends 40a of the groove 40, which locks each configuration into place. Supplemental guiding grooves can also be provided on the tubular part 27 to cooperate with internal ribs of the actuation member A.

This type of assembly of the selection device 20 in the second embodiment allows the second magnet 4 to rotate on a longitudinal axis perpendicular to the magnetically active side facing the first magnet 3. In this case, breaking the magnetic bond between the faces of the magnets 3, 4 is facilitated by the change in the superimposed complementary poles, which reduces the force to be exerted.

The actuation member A can have an extension along the tubular part 27 and defining a clip 5. The total length of the actuation member, including the additional length defining the clip 5, is thus much greater than the length of the second magnet 4. The internal volume required is reduced and gripping the actuation member A is particularly comfortable. As can be seen in FIGS. 6 and 7, the free end of the clip A extends much further forward than the first magnet 3, and the opposite end of the actuation member A defines a tapered back end 10b of the barrel 10.

The second embodiment therefore offers satisfactory ergonomics comparable to those of a writing implement with a cap which attaches to the back. Air is also allowed to enter, by means of passages through the back end of the apparatus 11 and the selection device 20. Here the rear air vent 16 is centered around the longitudinal axis of the barrel 10 but can be offset to the side in a variant.

In a variant embodiment, the selection device 20 can also advance relative to the rest of the barrel 10 to increase the amplitude d of the displacement of the writing tip 2. Thus the semicircular groove 40 inside the actuation member A could be replaced by a helicoid groove. More generally, it is understood that the selection device 20 can connect the actuation member A to the pivot axis X of the second magnetic member 4 in a manner that creates a forward advancement of the magnet 4 when the selection device 20 changes to the second configuration.

In the example in FIG. 10, the groove or grooves 42 allow a primarily helicoid displacement of the selection device 20. With this arrangement, the second magnet 4 remains coaxial with the barrel 10 and is axially displaced inside the tubular part 27. The grooves 42 can be replaced by any means that guide the selection device 20. Such guiding means have at least one end for guiding the selection device 20 essentially in its rotational motion. With reference to FIG. 10, the ends 42a, 42b of the grooves 42 thus allow first rotationally guiding the second magnet during the phases of configuration changes. In the case of breaking the magnetic bond between the magnets 3, 4, this allows first modifying the field lines before the second magnet 4 is pushed forward. In the case of retraction, this allows first considerably reducing the repulsion force before the second magnet 4 is pulled backward.

In other words, the actuation member A initially causes a rotation of the second magnet 4 which has the effect of decreasing the magnetic repulsion or attraction. In particular, this arrangement facilitates the return to the retracted position which typically corresponds to the apparatus 11 rising under the effect of the magnetic attraction. In particular, it avoids increasing the distance between the magnets 3, 4, as too great a distance is more difficult to compensate for with magnetic attraction.

One of the advantages of the embodiments of the present invention lies in the effect of magnetic cushioning obtained while writing. In addition, the writing tip 2 can be completely retracted simply by activating a rotating selection device 20 on the periphery of the tubular body of the writing implement 1.

It is understood that each of the examples and each of the details of the embodiments described above can be used separately or in combination. It is obvious to a person skilled in the art that the invention allows embodiments in other specific forms without falling outside the scope of the claimed invention.

1.-10. (canceled)

11. A writing implement comprising:
a tubular body extending longitudinally between a front end and a back end;
a writing member that is movable relative to the body between an extended position in which the writing member projects from the front end of the body and a retracted position in which the writing member is housed inside the body;
a first magnetic member secured to the writing member and movable with the writing member; and
a selection device comprising a second magnetic member and an actuation member, adapted for moving from a first configuration of the device in which the writing member is in the retracted position, to a second configuration in which the writing member is in the extended position,
wherein the first magnetic member and the second magnetic member are arranged inside the body and
wherein in the first configuration the first and second magnetic members have opposite magnetic poles in contact with each other, and in the second configuration the first and second magnetic members have poles of the same polarity substantially facing one another, generating a repulsion force which urges the writing member towards a maximum extended position in which the writing member is in contact with a longitudinal abutment of the body and remains backwardly movable, the repulsion force in the second configuration being adapted to cushion a writing pressure, the second magnetic member rotating on a pivot axis by a predetermined angle between the two configurations.

12. The writing implement according to claim 11, wherein the first and second magnetic members have faces in planes transverse to the body in the first and second configurations.

13. The writing implement according to claim 11, wherein the body has locking members which lock the actuation member in positions corresponding to the first and second configurations.

14. The writing implement according to claim 11, wherein the actuation member is radially offset relative to the body.

15. The writing implement according to claim 14, wherein the actuation member is an elongated member extending along the outer wall of the body.

16. The writing implement according to claim 15, wherein the actuation member has a length substantially greater than the largest dimension of the second magnetic member.

17. The writing implement according to claim 14, wherein the actuation member is pivotably mounted on a transverse axis.

18. The writing implement according to claim 17, wherein the actuation member (A) defines a clip.

19. The writing implement according to claim 14, wherein the actuation member is secured to a pin defining the pivot axis and bearing an internal support onto which the second magnetic member is mounted, and wherein the support, the pin, and the actuation member are formed as a single part.

20. The writing implement according to claim 11, wherein the second magnetic member is rotationally movable relative to a longitudinal axis and is secured to the actuation member.

21. The writing implement according to claim 20, wherein the selection device surrounds the back end of the body.

22. The writing implement according to claim 11, wherein the selection device further comprises a mechanism connecting the actuation member to the pivot axis of the second magnetic member, the mechanism being adapted so that the second magnetic member moves forward when the selection device is changed from the first configuration to the second configuration, and the second magnetic member moves backward when the selection device is changed from the second configuration to the first configuration.

23. The writing implement according to claim 11, wherein the writing member comprises a shoulder that is in contact with the longitudinal abutment in the maximum extended position.
